(19) United States
(12) Patent Application Publication
(10) Pub. No.: US 2009/0027718 A1
(43) Pub. Date: Jan. 29, 2009

(54) WORKFLOW MANAGEMENT SYSTEM

(76) Inventors: Takeshi SUZUKI, Kanagawa (JP); Kaoru MAEDA, Chiba (JP); Yoshiro MATSUI, Saitama (JP); Harald HOLZ, Kaiserslautern (DE); Oleg ROSTANIN, Kaiserslautern (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/045,234

(22) Filed: Mar. 10, 2008

(30) Foreign Application Priority Data
Mar. 19, 2007 (JP) 2007-071603

(51) Int. Cl. G06F 3/12

(52) U.S. Cl. 358/1.15

(57) ABSTRACT

A workflow management system capable of directly capturing image information transmitted by a facsimile machine is disclosed. The workflow management system includes an object identifying unit identifying an object to be associated with image information received by a facsimile machine, the object being defined in the workflow management system; and a related document registering unit associating the image information with the identified object, and registering the image information associated with the identified object.

### BACKGROUND OF THE INVENTION

1. Field of the Invention

The present invention relates to a workflow management system capable of dynamically configuring a workflow model upon executing the workflow by reusing workflow parts.

2. Description of the Related Art

A workflow management system using a personal computer connected to a network is described in, for example, Patent Document 1. The workflow management system is a client/server system connected to a computer network where a workflow is generally completed in processes in the computer network. In such a system, a paper document can hardly be used as a part of the workflow. This is disadvantageous because so many paper documents are usually used in common offices.

A technique to attempt to include a paper document in a workflow management system is described in, for example, Patent Document 2. The technique allows a process to put a seal on a document. By focusing on the difference between a digital document and a paper document, the technique overcomes the different characteristics of the different media by processing those media in parallel so as to include the paper document in a workflow. A similar technique is also described in, for example, Patent Document 3. However, those techniques are dedicated to handling large amounts of routine work and cannot dynamically change the workflow.

A technique capable of dynamically changing a workflow is described in, for example, Patent Document 4. The technique in Patent Document 4, however, focuses on a case where an actual operator involved in a workflow is changed. According to the technique, the definition of a workflow is divided into two levels, a role and an actual operator, thereby enabling a workflow to be dynamically changed. Unfortunately, when a role is not previously determined, this technique cannot be used.

Similar to Patent Document 4, a technique in Patent Document 5 can dynamically define a workflow especially when plural operators involved in the same workflow update the workflow at the same time. The simultaneous updates of a workflow can be achieved by adding means for collectively controlling the timings of updating the workflow and an order of priority in time domain is added to each task. However, the technique does not provide any determination whether a task should be performed or any verification of the validity of the task, but provides determination in time domain only. As a result, the technique may not be used for a workflow in a network including plural kinds of apparatuses.

In office operations so far, facsimile machines have been widely used for providing information printed on paper. As an MFP (Multi Function Peripheral, an apparatus having functions including a printer, a scanner, and a facsimile machine) and a facsimile transmission function using a personal computer have become popular, a function of storing received facsimile data as digital image data without printing out the data has been put into practice. This function is described in, for example, the Internet Fax standard.

Unfortunately, according to such functions, facsimile information is handled as image information and cannot be sufficiently involved in a digitized workflow. For example, association of received facsimile information with a workflow as image information is required to be performed manually using a screen on, for example, a personal computer. This is because, essentially it is not possible to identify a workflow and a task that should be associated with information obtained from a facsimile machine based on the techniques.

On the other hand, the inventors of the present invention have invented a workflow management system (see Patent Document 6) based on characteristics of the individual apparatus. More specifically, an imaging apparatus can be integrated into a workflow by allowing for dynamically changing the task configuration by, for example, adjusting and displaying the abstractiveness of a workflow based on the input/output characteristics of plural imaging apparatuses connected to the network.

In a further developed system (see Patent Document 7) using an imaging device, a workflow technology is described in which Optical Character Recognition (OCR) and water marking are used. However, the technology is for updating the status of a task of a workflow, and a facsimile document cannot be associated with a task and managed.

A task is created dynamically and executed by a user. As a result, both digital and paper documents are created. Since those documents are created from the task, it is rational to associate the documents with the task. This technique is has been applied separately as an invention as a “Scan2Task” or “Scan To Task” function. However, this technology is based on a scanning function of, for example, a multi-functional copier, and facsimile information transmitted as digital information is not directly used. In some types of facsimile machines currently available, the Internet Facsimile machine and the like, it is possible to verify information on a screen without printing out a paper. Therefore, the above “Scan To Task” function does not work because printing information on a paper is not always necessary as described.

Patent Document 1: Japanese Patent Application Publication No. 2002-245214

Patent Document 2: Japanese Patent Application Publication No. 2000-3402

Patent Document 3: Japanese Patent Application Publication No. H11-143980

Patent Document 4: Japanese Patent Application Publication No. 2000-259736

Patent Document 5: Japanese Patent Application Publication No. H8-221486

Patent Document 6: Japanese Patent Application Publication No. 2006-243830

Patent Document 7: Japanese Patent Application Publication No. 2006-215853

### SUMMARY OF THE INVENTION

The present invention is made in light of the above problems, and may provide a workflow management system capable of directly capturing facsimile-transmitted image information in a workflow.

To solve the above problems, according to a first aspect of the present invention, there is provided a workflow management system capable of being dynamically configured by re-using a part of a workflow during the workflow execution. The workflow management system includes an object identifying unit identifying an object to be associated with image information received by a facsimile machine, the object being defined in the workflow management system; and a related document registering unit associating the image information with the identified object, and registering the image information associated with the identified object.

According to a second aspect of the present invention, in the workflow management system according to the first aspect of the present invention, the object identifying unit identifies the object based on a sender's information of the received image information.

According to a third aspect of the present invention, the workflow management system according to the second aspect of the present invention further includes a unit omitting a subsequent process when the sender's information is registered to be blocked.

According to a fourth aspect of the present invention, in the workflow management system according to the first aspect of the present invention, the object identifying unit extracts text information included in the received image information, and identifies the object based on the extracted text information.

According to a fifth aspect of the present invention, the workflow management system according to the fourth aspect of the present invention further includes a unit changing a task configuration of the workflow when a prescribed term is included in the extracted text information.

According to a sixth aspect of the present invention, the workflow management system according to the first aspect of the present invention further includes a unit informing a user relevant to the object that the received image information is registered when the related information registering unit associates the image information received by the facsimile machine with the identified object, and registers the image information associated with the identified object.

According to a seventh aspect of the present invention, the workflow management system according to the first aspect of the present invention further includes a unit providing related information associated with the object to a user relevant to the object when the related information registering unit associates the image information received by the facsimile machine with the identified object, and registers the image information associated with the identified object.

According to a eighth aspect of the present invention, there is provided a method of managing workflow management systems capable of being dynamically configured by re-using a part of a workflow during the workflow execution. The method includes a step of identifying an object to be associated with image information received by a facsimile machine, the object being defined in the workflow management system, and a step of associating the image information with the identified object, and registering the image information associated with the identified object.

According to a ninth aspect of the present invention, there is provided a program for controlling a workflow management system capable of being dynamically configured by re-using a part of a workflow during the workflow execution. The program causes a computer as a unit identifying an object to be associated with image information received by a facsimile machine, the object being defined in the workflow management system, and a unit associating the image information with the identified object and registering the image information associated with the identified object.

In a workflow management system according to an embodiment of the present invention, facsimile-transmitted image information can be captured directly in a workflow, and a digital workflow and information managed by a facsimile machine can be linked seamlessly.

### BRIEF DESCRIPTION OF THE DRAWINGS

Other objects, features, and advantages of the present invention will become more apparent from the following descriptions when read in conjunction with the accompanying drawings, in which:

FIG. 1 is a drawing showing an exemplary configuration of a workflow management system according to an embodiment of the present invention;

FIG. 2 is a drawing showing an exemplary allocation of the elements of workflow management system;

FIG. 3 is a drawing showing an example of task configuration a workflow;

FIG. 4 is a table showing an exemplary configuration of task instance data;

FIG. 5 is a sequence diagram showing an exemplary process of the workflow management system according to an embodiment of the present invention;

FIG. 6 is a sequence diagram showing another exemplary process of the workflow management system;

FIG. 7 is a sequence diagram showing still another exemplary process of the workflow management system;

FIG. 8 is a sequence diagram showing still another exemplary process of the workflow management system;

FIGS. 9A and 9B are a sequence diagram showing still another exemplary process of the workflow management system;

FIG. 10 is a drawing showing an exemplary task related information list; and

FIG. 11 is a flowchart of an exemplary process showing what information is provided depending on cases to a user in an interactive mode.

### DETAILED DESCRIPTION OF THE PREFERRED EMBODIMENTS

In the following, an exemplary embodiment of the present invention is described with reference to the accompanying drawings.

### <System Configuration>

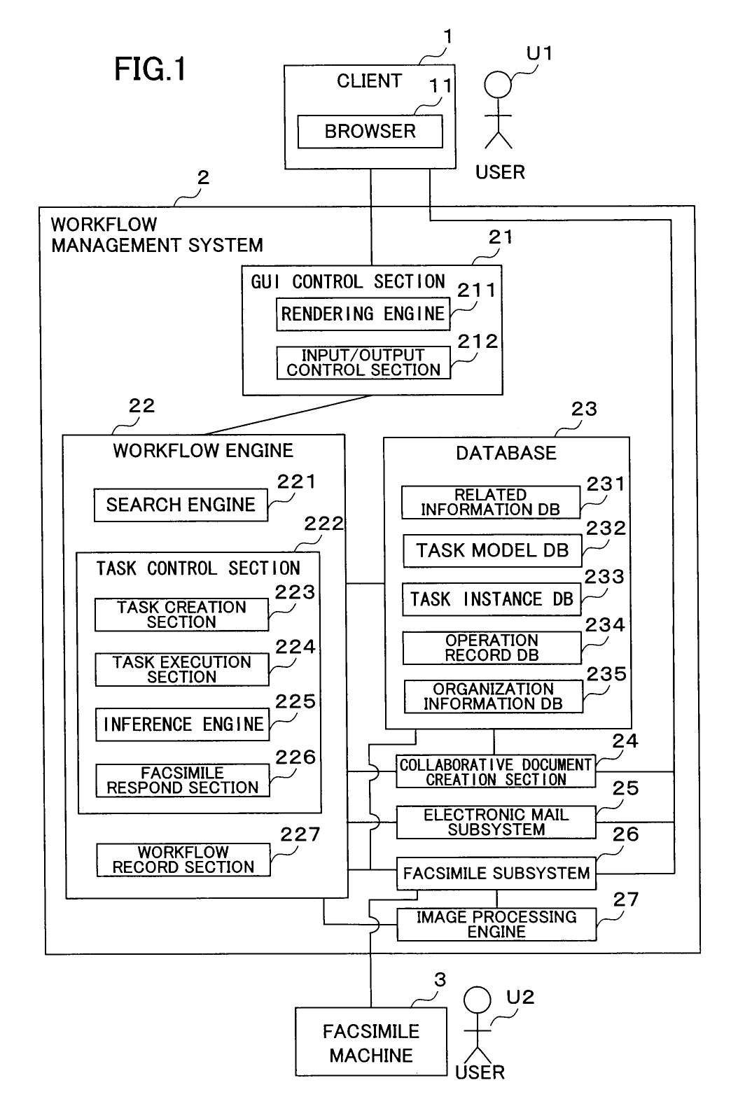

FIG. 1 shows an exemplary configuration of a workflow management system according to an embodiment of the present invention.

In FIG. 1, the workflow management system 2 includes a GUI control section 21 providing a Graphical User Interface (GUI) viewed in a browser 11 on a client 1 such as a personal computer (PC) operated by a user U1, a workflow engine 22 dynamically creating and executing a workflow model by reusing any one of an existing task model and an existing task instance or both, a database 23 storing information necessary for processing, a collaborative document creation section 24 made of a Contents Management System (CMS) such as Wiki, an electronic mail subsystem 25 having a function of sending and receiving electronic mail, a facsimile subsystem 26 having a function of sending and receiving facsimiles and managing facsimile information, and an image processing engine 27 analyzing a received facsimile image using, for example, OCR and extracting text information from the image. The facsimile subsystem 26 is connected to a facsimile machine 3 used by a user U2. It should be noted that the user U2 using the facsimile machine 3 may be the same as the user U1 using the workflow management system 2.

The database 23 includes a related information DB (DataBase) 231 storing related information referred to when a workflow is executed, a task model DB 232 storing a task model previously abstracted by, for example, an administrator of the system, a task instance DB 233 storing a task instance, an operation record DB 234 storing an operation record of a workflow, and an organization information DB 235 storing information of a user and a user group to which the user belongs. The information in the task model DB 232 and task instance DB 233 is linked to the information registered in the related information DB 231.

The GUI control section 21 includes a rendering engine 211 for drawing a display image and an input/output control section 212 for exchanging information with the user U1.

The workflow engine 22 includes a search engine 221 executing various searches with respect to the database 23, a task control section 222 controlling tasks constituting a workflow, and a workflow record section 227 referring to the database 23, monitoring the operations of the user U1 and the workflow management system 2, and storing the operation records of a workflow in the operation record DB 234.

The task control section 222 includes a task creation section 223 creating a task, a task execution section 224 executing the created task, an inference engine 225 inferring a current task of the user U1 from the information of the operation record DB 234 and searching for related information from the database 23, and a facsimile respond section 226 performing a prescribed process of, for example, attaching a received image to a task in accordance with sender's information or contents of the facsimile received by the facsimile subsystem 26.

As an outline of a basic operation of a workflow control, the user U1 operates the workflow engine 22 via the input/output control section 212 of the GUI control section 21 to create and execute a workflow, create a workflow model, register related information and a document, and link those data to a workflow instance and a workflow mode.

When a workflow is created, the search engine 221 in the workflow engine 22 performs various searches with respect to the database 23.

The task control section 222 in the workflow engine 22 controls a task by using the task model DB 232 and task instance DB 233 in accordance with, for example, an instruction of the user U1. The task creation section 223 in the task control section 222 creates a task and links information and the like based on the information in the database 23 in accordance with an instruction of the user U1. The task execution section 224 updates task information (task execution refers to the update of task information when viewed from the system) by using the information in the task instance DB 233 in accordance with an instruction of the user U1. The inference engine 225 infers a current task of the user U1 from the information of the operation record DB 234, and searching for related information in the database 23.

The workflow record section 227 monitors the operations of the user U1 and the workflow management system 2, and stores the operation records of a workflow in the operation record DB 234.

Main functions relevant to the present invention are as follows:

(1) A function to identify an object (task, workflow, project) relevant to received facsimile information by using the information obtained from the facsimile subsystem 26, and associate the received facsimile information with the identified object; and
(2) A function to create facsimile information from the task information in the system, and send the created information as facsimile information or electronic mail (e-mail) information.

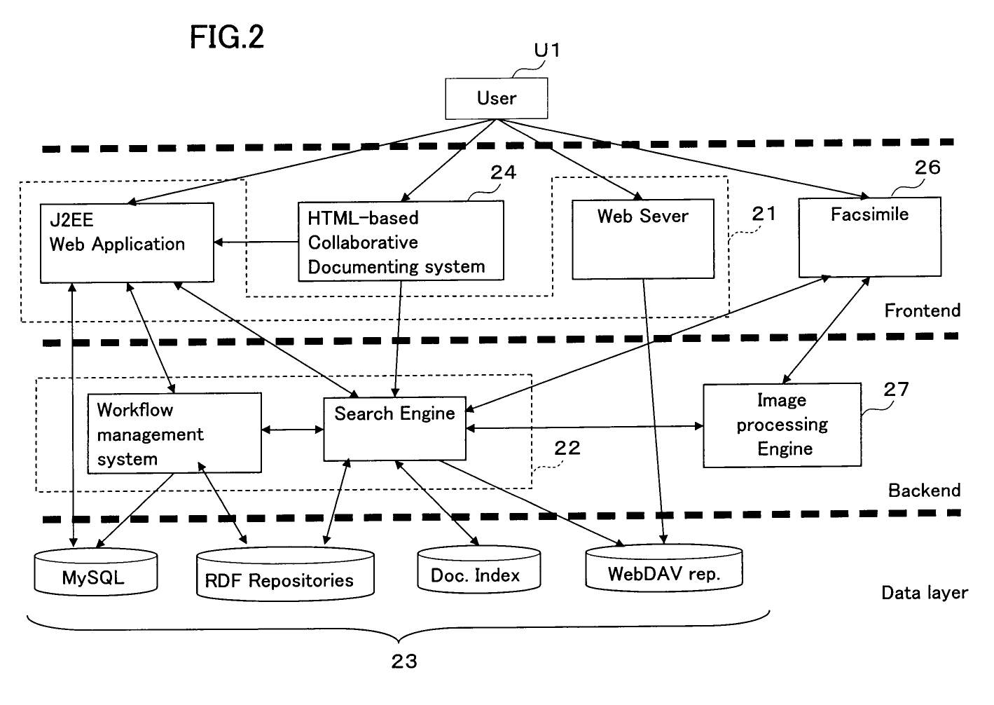

FIG. 2 shows an exemplary allocation of the workflow management system 2. In FIG. 2, the combination of the “Web Server” and the “J2EE Web Application” corresponds to the GUI control section 21. The “HTML-based Collaborative Documenting System” corresponds to the collaborative document creation section 24. The “Facsimile” corresponds to the facsimile subsystem 26. Those elements constitute a Frontend of the system. Namely, the Web server and the HTML-based collaborative document creation system are provided so that the user U1 can access the system using the Web browser (browser 11). In this exemplary allocation, since the user U1 accesses the system using a Web browser, it is necessary to manage access to a file on the network. It is assumed that a file management system such as “NetDrive” capable of operating on the network is used to realize the functions of the system according to an embodiment of the present invention.

Further, the combination of the “Workflow Management System” and the “Search Engine” corresponds to the workflow engine 22. The “Image processing Engine” corresponds to the image processing engine 27. Those elements constitute a Backend of the system. Since fundamental functions of the workflow management system according to an embodiment of the present invention are substantially the same as those of a conventional system, an engine typically used in a conventional workflow management system may also be used in a system according to an embodiment of the present invention. Further, as for a search engine for searching for a task and related information, a general query-based search engine may also be used in the system.

Further, the combination of the “MySQL”, the “RDF Repositories”, the “Doc. Index”, and the “WebDAVrepos” corresponds to the database 23, constituting a data layer. The task information and the related information is managed as an RDF repository, and related information and the like is managed by a document depository and an index server. The former corresponds to the task model DB 232 and a task instance DB 233 in FIG. 1. The latter corresponds to the related information DB 231. The user information and the organization information are managed as an RDF repository as well. The information corresponds to the organization information DB 235 in FIG. 1.

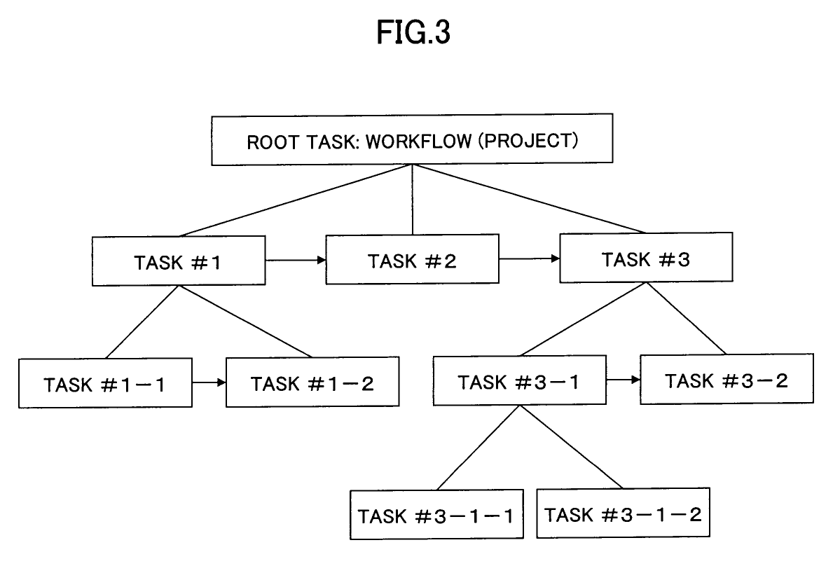

FIG. 3 shows a drawing of an exemplary structure of a workflow. In FIG. 3, a root task: workflow (project) includes an arbitrary number of tasks. Each task may include a layered arbitrary number of subtasks. Namely, a workflow may include plural tasks, and each task may include plural subtasks. For example, the order relationship between them (see arrow lines in FIG. 3) is the same as that in a general workflow management system. Further, each task and each subtask may include related information and a related document.

The term “task instance” refers to an entity of a task managed separately. On the other hand, the term “task model” or “process type” refers to an entity as a model having such higher abstractness that represents the task instance.

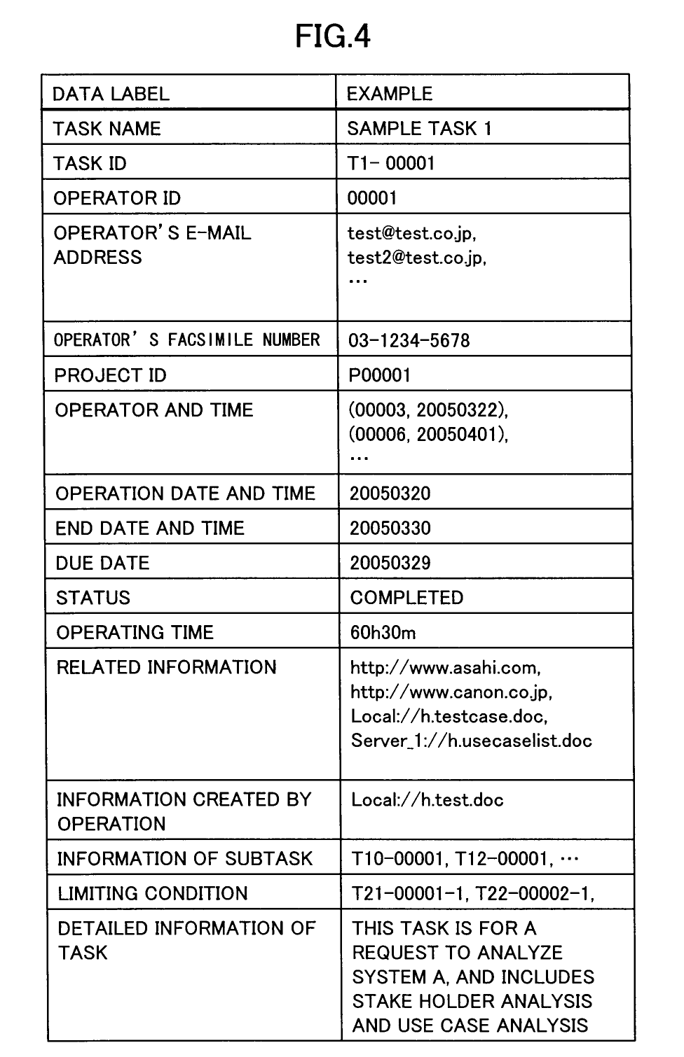

FIG. 4 is a table showing an exemplary configuration of task instance data, including the items of “task name”, “task ID”, “operator ID”, “operator's e-mail address”, “operator's facsimile number”, “project ID”, “operator and time”, “operation date and time”, “end date and time”, “due date”, “status”, “operating time”, “related information”, “information created by operation”, “information of subtask”, “limiting condition”, and “detailed information of task”. It should be noted that the information of the operator's e-mail address and the operator's facsimile number may be managed in, for example, a database in another data layer, and data may be entered for the operator's e-mail address and the operator's facsimile number.

### <Operations>

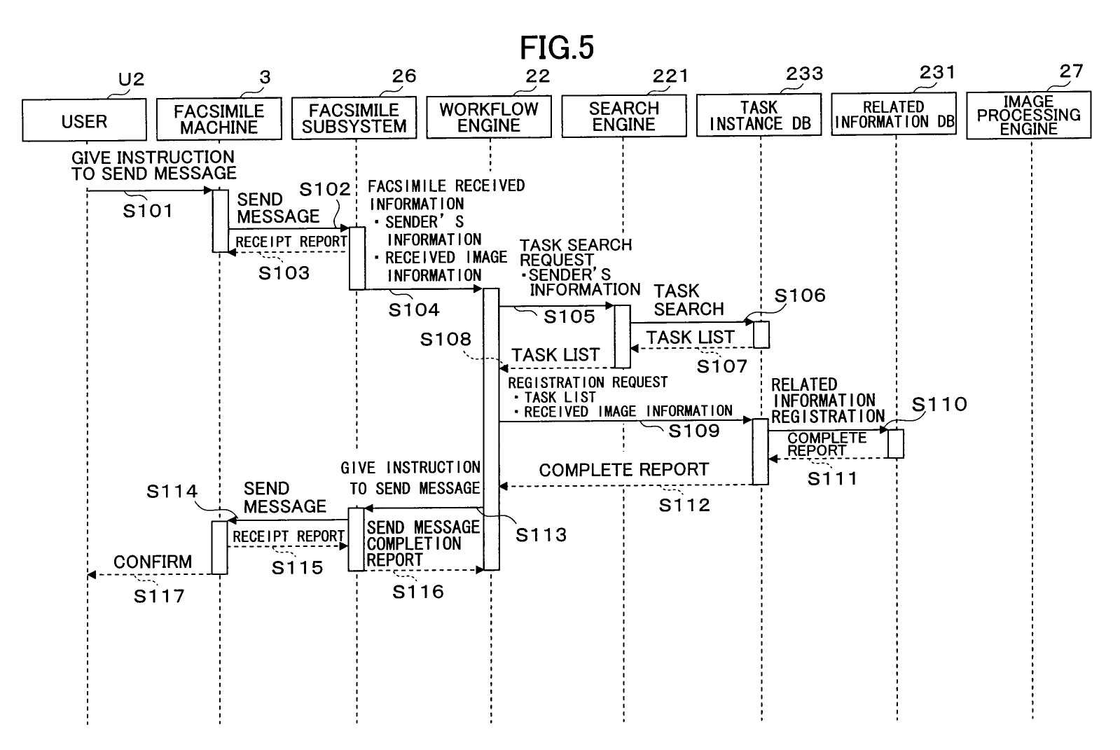

FIG. 5 is a sequence diagram showing an exemplary process of the workflow management system according to an embodiment of the present invention.

In FIG. 5, an outside user U2 gives an instruction to a facsimile machine 3 to send a message (in step S101). The facsimile machine 3 sends the message to the facsimile subsystem 26 in the workflow management system 2 (in step S102). After receiving the message correctly, the facsimile subsystem 26 informs the facsimile machine 3 of the receipt of the message (in step S103). Then, the facsimile subsystem 26 informs the workflow engine 22 of the sender's information (facsimile number) and facsimile received information including received image information (in step S104).

Next, the workflow engine 22 sends the sender's information and a search task request to the search engine 221 (in step S105). The search engine 221 performs the search task in the task instance DB 233 (in step S206), acquires a task list as a search result (in step S107), and sends the acquired task list back to the workflow engine 22 (in step S108). More specifically, the search is performed in each task (task instance) having the data structure shown in FIG. 4 and the item “operator's facsimile number” is searched for using the sender's information as a search term. As a result, a list of corresponding tasks is obtained (found).

Next, referring back to FIG. 5, the workflow engine 22 sends the acquired task list, the received image information, and a request to register a related document (in step S109). The task instance DB 233 stores the received image information in the related information DB 231 as the related information of the searched for and found tasks (in step S110), receives information that the registration is completed from the related information DB 231 (in step S111), and sends the received information to the workflow engine 22 (in step S112).

Then, the workflow engine 22 sends a message to the facsimile subsystem 26 to inform the user U2 by facsimile machine that the registration of the related information is completed (in step S113). The instruction to send a facsimile message includes information to identify the facsimile machine 3 of the user U2 (received sender's information, operator's facsimile number in FIG. 4).

The facsimile subsystem 26 sends the message by facsimile to the facsimile machine 3 (in step S114), receives information that the facsimile machine 3 has correctly received the message from the facsimile subsystem 26 when the message is correctly received (in step S115), and informs the workflow engine 22 that the message transmission is completed (in step S116). In addition, the user U2 confirms the received message on the facsimile machine 3 (in step S117).

In the above description, facsimile transmission is used to inform the user U2 that the registration of the related information is completed. However, instead of using the facsimile, only e-mail or both facsimile and e-mail may be used. In such a case, a message transmission request along with a mail address (operator's e-mail address in FIG. 4) is to be transmitted to the electronic mail subsystem 25.

Further, in the above description, the message is transmitted to the user U2 who performs the facsimile transmission. However, the process may be modified so that the message can be sent to other users relevant to the task (a creator or a user relevant to the task or the upper task of the task or uppermost workflow (project)) in addition to the user U2 by any one of facsimile and e-mail or both.

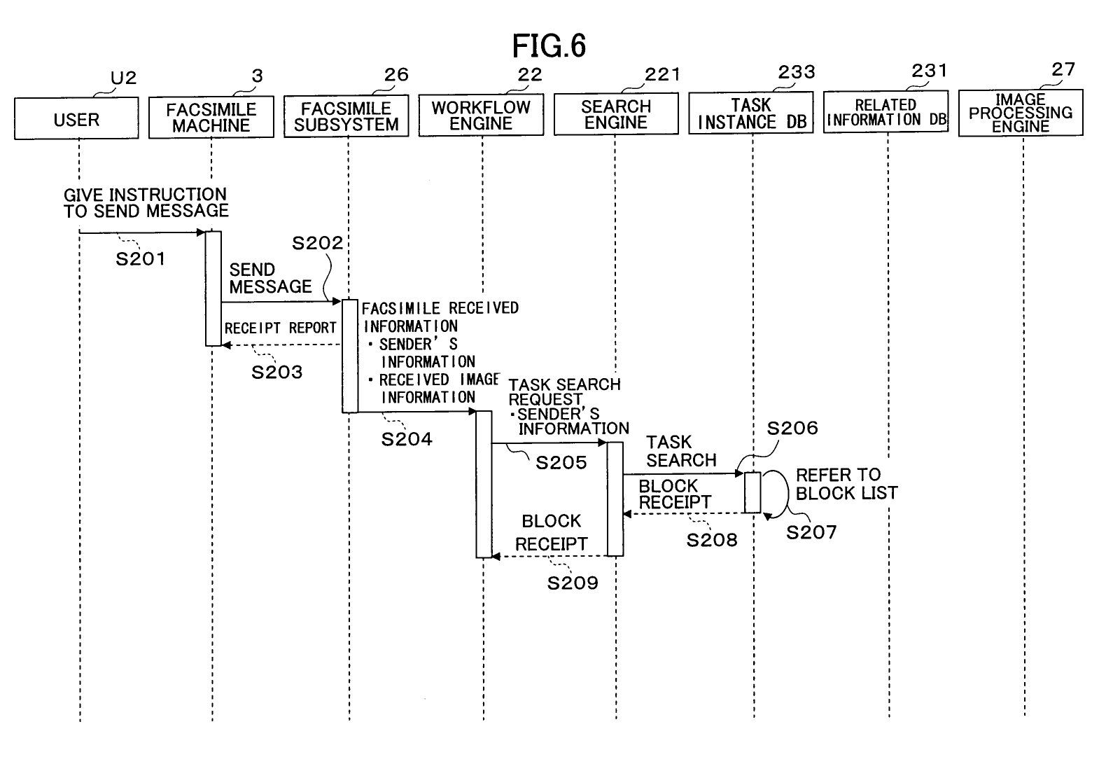

FIG. 6 is a sequence diagram showing another exemplary process of the workflow management system according to an embodiment of the present invention. As shown in FIG. 6, the task instance DB 23 includes a block list listing prescribed facsimile numbers so as to block a message irrelevant to the workflow such as an advertising message to the facsimile machine 3.

In FIG. 6, an outside user U2 gives an instruction to a facsimile machine 3 to send a message (in step S201). The facsimile machine 3 sends the message to the facsimile subsystem 26 in the workflow management system 2 (in step S202). After receiving the message correctly, the facsimile subsystem 26 informs the facsimile machine 3 of the receipt of the message (in step S203). Then, the facsimile subsystem 26 informs the workflow engine 22 of the sender's information (facsimile number) and facsimile received information including received image information (in step S204).

Next, the workflow engine 22 sends a sender's information and a search task request to the search engine 221 (in step S205). The search engine 221 performs the search task in the task instance DB 233 (in step S206). Then, the task instance DB 233 refers to the block list stored inside (in step S207), and when the sender's information corresponds to any entry in the block list, informs the search engine 221 so as to block the receipt (in step S208). The search engine 221 informs the workflow engine 22 of the information to block the receipt (in step S209). The workflow engine 22 ends the process of the facsimile received information.

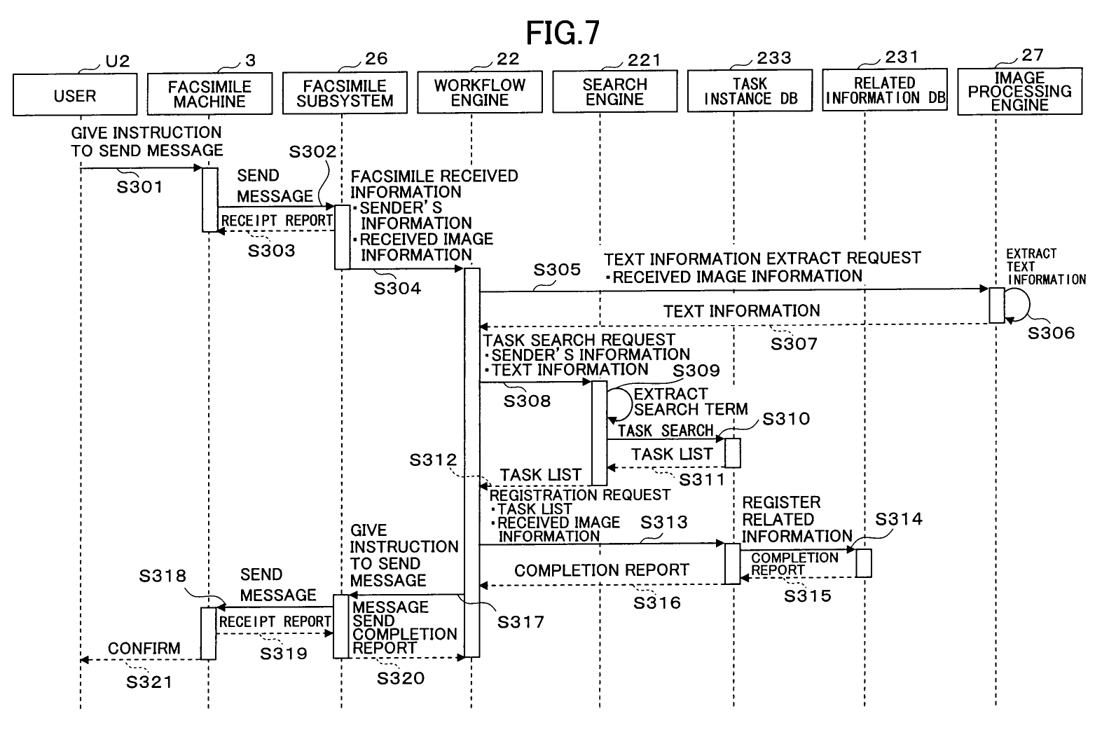

FIG. 7 is a sequence diagram showing still another exemplary process of the workflow management system according to an embodiment of the present invention. As shown in FIG. 7, when a task is identified to be associated with a received image, in addition to the sender's information, text information extracted from the received image is used so as to improve the accuracy of identifying the task.

In FIG. 7, an outside user U2 gives an instruction to a facsimile machine 3 to send a message (in step S301). The facsimile machine 3 sends the message to the facsimile subsystem 26 in the workflow management system 2 (in step S302). After receiving the message correctly, the facsimile subsystem 26 informs the facsimile machine 3 of the receipt of the message (in step S303). Then, the facsimile subsystem 26 informs the workflow engine 22 of the sender's information (facsimile number) and facsimile received information including received image information (in step S304).

Next, the workflow engine 22 sends a sender's information and a search task request to the image processing engine 27 (in step S305). The image processing engine 27 extracts text information from the received image information using an analysis technique such as OCR (in step S306), and sends the extracted text information back to the workflow engine 22 (in step S307).

Next, the workflow engine 22 sends the sender's information, the extracted text information, and a task search request to the search engine 221 (in step S308). The search engine 221 extracts a search term from the received text information (in step S309). There are various methods to extract a search term from text information, including an application software product “BrainFiler” (http://barinabot.com/site3/produkte/brainfiler) of BrainBot technologies.

Next, the search engine 221 searches for a task in the task instance DB 233 using the search term extracted from the sender's information and the text information (in step S310), acquires a task list as a search result (in step S311), and sends the acquired task list back to the workflow engine 22 (in step S312). As described above, the task search using the sender's information is performed by using the item “operator's facsimile number” of the task instance data shown in FIG. 4. On the other hand, when the task search using the search term extracted from the text information is performed, all the items of the task instance data can be used as the target of the search. It should be noted that a search may be performed using only the prescribed items such as the “task name” and the “detailed information of task” so as not to search for irrelevant tasks.

Next, referring back to FIG. 7, the workflow engine 22 sends the task list, the received image information, and a related document registration request to the task instance DB 233 (in step S313). The task instance DB 233 registers the received image information as the related information of the searched for and found task in the related information DB 231 (in step S314), is informed that the registration is completed when the registration is completed (in step S315), and informs the workflow engine 22 that the registration is completed (in step S316).

Then, the workflow engine 22 sends a message to the facsimile subsystem 26 to inform the user U2 by facsimile machine that the registration of the related information is completed (in step S317). The instruction to send a facsimile message includes information to identify the facsimile machine 3 of the user U2 (received sender's information, operator's facsimile number in FIG. 4).

The facsimile subsystem 26 sends the message by facsimile to the facsimile machine 3 (in step S318), receives information that the facsimile machine 3 has correctly received the message from the facsimile subsystem 26 when the message is correctly received (in step S319), and informs the workflow engine 22 that the message transmission is completed (in step S320). In addition, the user U2 confirms the received message on the facsimile machine 3 (in step S321).

In the above description, facsimile transmission is used to inform the user U2 that the registration of the related information is completed. However, instead of using the facsimile, only e-mail or both facsimile and e-mail may be used. In such a case, a message transmission request along with a mail address (operator's e-mail address in FIG. 4) is to be transmitted to the electronic mail subsystem 25.

Further, in the above description, the message is transmitted to the user U2 who performs the facsimile transmission. However, the process may be modified so that the message can be sent to other users relevant to the task (a creator or a user relevant to the task or the upper task of the task or uppermost workflow (project)) in addition to the user U2 by any one of facsimile and e-mail or both.

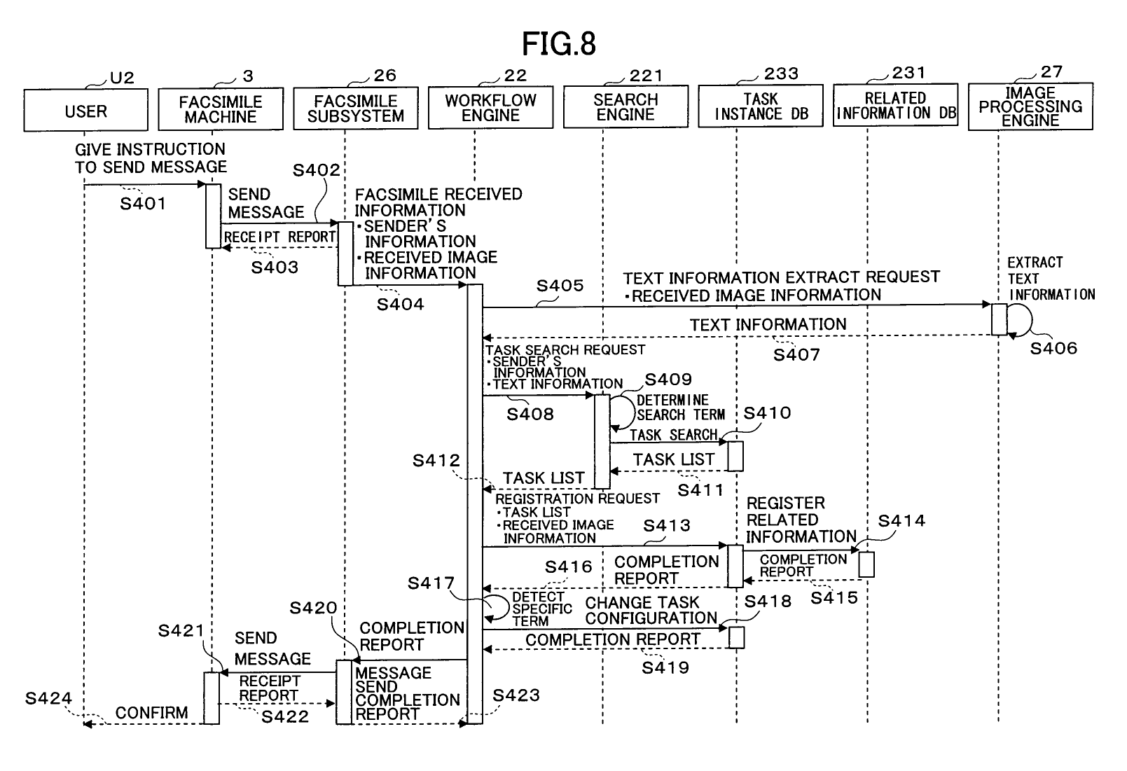

FIG. 8 is a sequence diagram showing still another exemplary process of the workflow management system according to an embodiment of the present invention. As shown in FIG. 8, when the text information is extracted from the received image after the received image is registered in the task as the related information, the task configuration of the workflow can be appropriately changed. In a typical workflow, depending on the type or contents of a document input by a user, the following operating flow may be frequently changed. The operating flow can be automatically changed when the configuration as shown in FIG. 8 is employed.

In FIG. 8, an outside user U2 gives an instruction to a facsimile machine 3 to send a message (in step S401). The facsimile machine 3 sends the message to the facsimile subsystem 26 in the workflow management system 2 (in step S402). After receiving the message correctly, the facsimile subsystem 26 informs the facsimile machine 3 of the receipt of the message (in step S403). Then, the facsimile subsystem 26 informs the workflow engine 22 of the sender's information (facsimile number) and facsimile received information including received image information (in step S404).

Next, the workflow engine 22 sends a sender's information and a search task request to the image processing engine 27 (in step S405). The image processing engine 27 extracts text information from the received image information using an analysis technique such as OCR (in step S406), and sends the extracted text information back to the workflow engine 22 (in step S407).

Next, the workflow engine 22 sends the sender's information, the extracted text information, and a task search request to the search engine 221 (in step S408). The search engine 221 extracts a search term from the received text information (in step S409). There are various methods to extract a search term from text information, including an application software product “BrainFiler” (http://barinabot.com/site3/produkte/brainfiler) of BrainBot technologies.

Next, the search engine 221 searches for a task in the task instance DB 233 using the search term extracted from the sender's information and the text information (in step S410), acquires a task list as a search result (in step S411), and sends the acquired task list back to the workflow engine 22 (in step S412). The task search using the sender's information is performed by using the item “operator's facsimile number” of the task instance data shown in FIG. 4. On the other hand, when the task search using the search term extracted from the text information is performed, all the items of the task instance data can be used as the target of the search. It should be noted that a search may be performed using only the prescribed items such as the “task name” and the “detailed information of task” so as not to search for irrelevant tasks.

Next, referring back to FIG. 8, the workflow engine 22 sends the task list, the received image information, and a related document registration request to the task instance DB 233 (in step S413). The task instance DB 233 registers the received image information as the related information of the searched for and found task in the related information DB 231 (in step S414), is informed that the registration is completed when the registration is completed (in step S415), and informs the workflow engine 22 that the registration is completed (in step S416).

Next, the workflow engine 22 determines whether the text information extracted from the received image includes a specific term. When the specific term is detected (in step S417), the workflow engine 22 changes the task configuration in the task instance DB 233 (in step S418). When the task configuration is correctly changed, the workflow engine 22 is informed that the task configuration change is completed (in step S419).

Then, the workflow engine 22 sends a message to the facsimile subsystem 26 to inform the user U2 by facsimile machine that the registration of the related information is completed (in step S420). The instruction to send a facsimile message includes information to identify the facsimile machine 3 of the user U2 (received sender's information, operator's facsimile number in FIG. 4).

The facsimile subsystem 26 sends the message by facsimile to the facsimile machine 3 (in step S421), receives information that the facsimile machine 3 has correctly received the message from the facsimile subsystem 26 when the message is correctly received (in step S422), and informs the workflow engine 22 that the message transmission is completed (in step S423). In addition, the user U2 confirms the received message on the facsimile machine 3 (in step S424).

In the above description, facsimile transmission is used to inform the user U2 that the registration of the related information is completed. However, instead of using the facsimile, only e-mail or both facsimile and e-mail may be used. In such a case, a message transmission request along with a mail address (operator's e-mail address in FIG. 4) is to be transmitted to the electronic mail subsystem 25.

Further, in the above description, the message is transmitted to the user U2 who performs the facsimile transmission. However, the process may be modified so that the message can be sent to other users relevant to the task (a creator or a user relevant to the task or the upper task of the task or uppermost workflow (project)) in addition to the user U2 by any one of facsimile and e-mail or both.

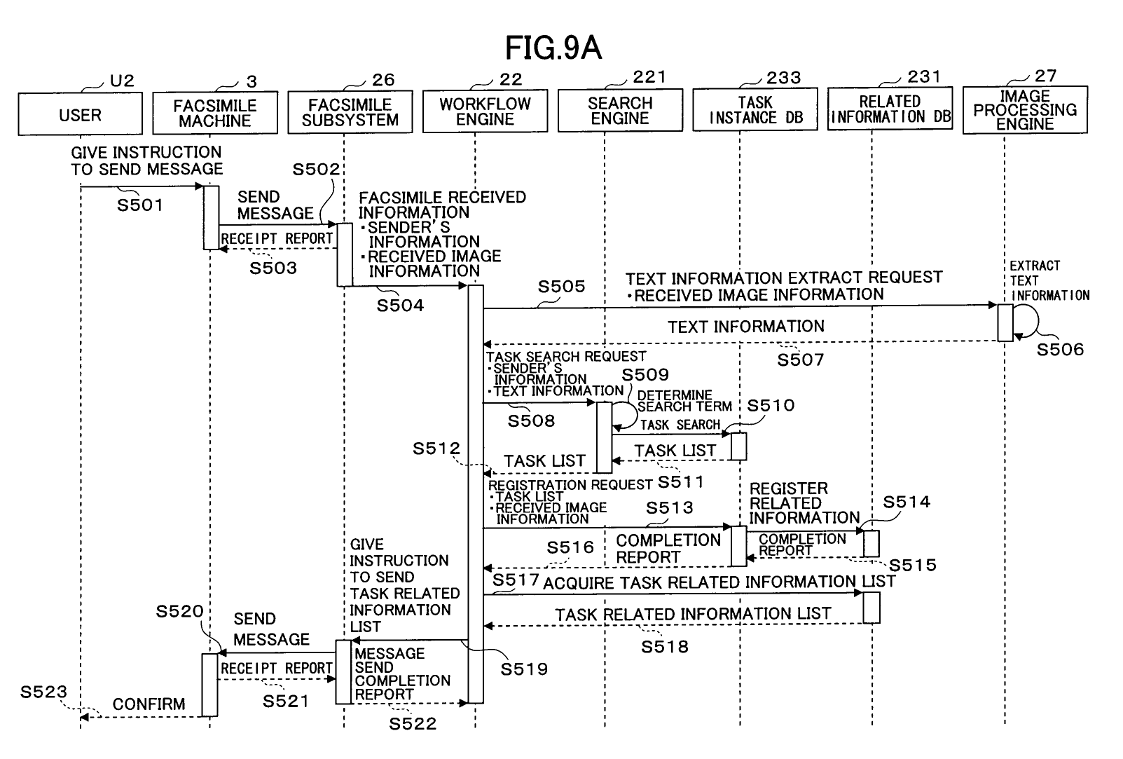

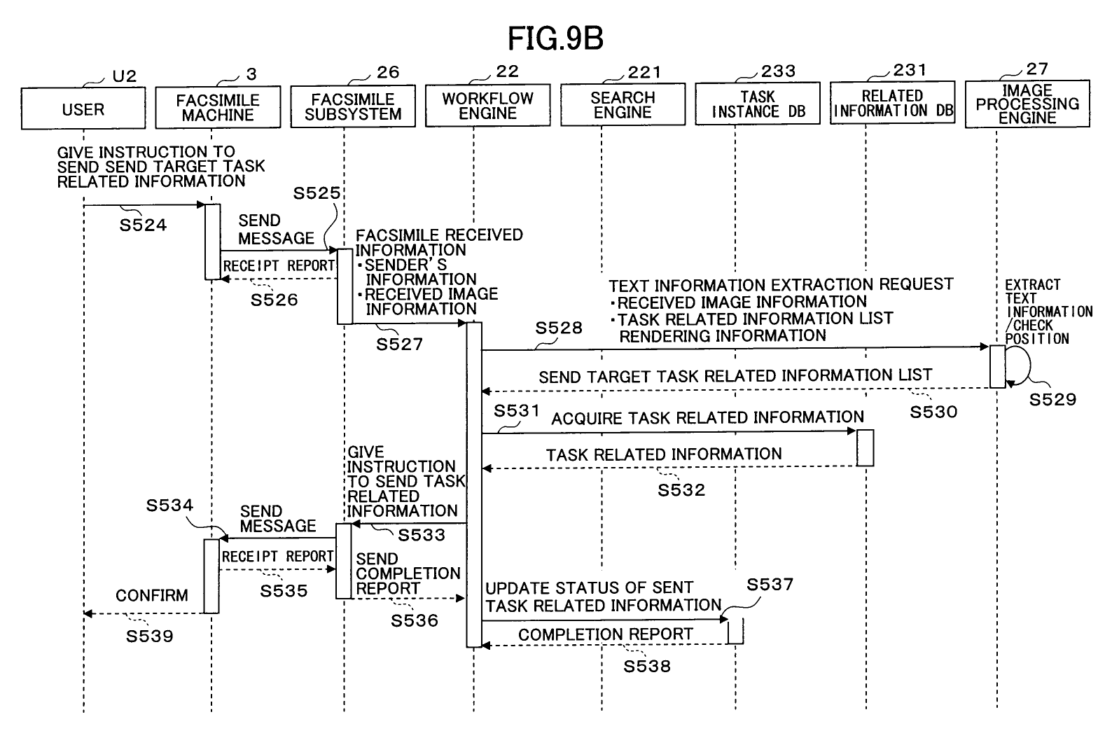

FIGS. 9A and B are sequence diagrams showing still another exemplary process of the workflow management system according to an embodiment of the present invention. As shown in FIGS. 9A and 9B, not only a message advising that the related information is registered is sent to the user U2 by, for example, a facsimile, but also a task related information (related document) list is sent to the user U2 so that the user U2 can send a request and receive further related information based on the request.

In FIG. 9A, an outside user U2 gives an instruction to a facsimile machine 3 to send a message (in step S501). The facsimile machine 3 sends the message to the facsimile subsystem 26 in the workflow management system 2 (in step S502). After receiving the message correctly, the facsimile subsystem 26 informs the facsimile machine 3 of the receipt of the message (in step S503). Then, the facsimile subsystem 26 informs the workflow engine 22 of the sender's information (facsimile number) and facsimile received information including received image information (in step S504).

Next, the workflow engine 22 sends the sender's information and a search task request to the image processing engine 27 (in step S505). The image processing engine 27 extracts text information from the received image information using an analysis technique such as OCR (in step S506), and sends the extracted text information back to the workflow engine 22 (in step S507).

Next, the workflow engine 22 sends the sender's information, the extracted text information, and a task search request to the search engine 221 (in step S508). The search engine 221 extracts a search term from the received text information (in step S509). There are various methods to extract a search term from text information, including an application software product “BrainFiler” (http://barinabot.com/site3/produkte/brainfiler) of BrainBot technologies.

Next, the search engine 221 searches for a task in the task instance DB 233 using the search term extracted from the sender's information and the text information (in step S510), acquires a task list as a search result (in step S511), and sends the acquired task list back to the workflow engine 22 (in step S512). The task search using the sender's information is performed by using the item “operator's facsimile number” of the task instance data shown in FIG. 4. On the other hand, when the task search using the search term extracted from the text information is performed, all the items of the task instance data can be used as the target of the search. It should be noted that a search may be performed using only the prescribed items such as the “task name” and the “detailed information of task” so as not to search for irrelevant tasks.

Next, referring back to FIG. 9A, the workflow engine 22 sends the task list, the received image information, and a related document registration request to the task instance DB 233 (in step S513). The task instance DB 233 registers the received image information as the related information of the searched for and found task in the related information DB 231 (in step S514), is informed that the registration is completed when the registration is completed (in step S515), and informs the workflow engine 22 that the registration is completed (in step S516).

Then, the workflow engine 22 sends a request to acquire a task related information list to the related information DB 231 (in step S517), and acquires the task related information list (in step S518).

Then, the workflow engine 22 sends a message to the facsimile subsystem 26 to inform the user U2 of the task related information list by facsimile machine (in step S519). The facsimile message includes information to identify the facsimile machine 3 of the user U2 (received sender's information, operator's facsimile number in FIG. 4).

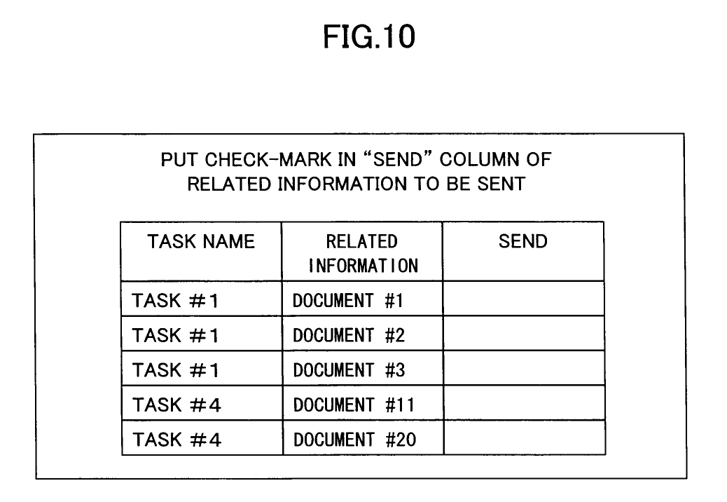

The facsimile subsystem 26 sends the message by facsimile to the facsimile machine 3 (in step S520), receives information that the facsimile machine 3 has correctly received the message from the facsimile subsystem 26 when the message is correctly received (in step S521), and informs the workflow engine 22 that the message transmission is completed (in step S522). In addition, the user U2 confirms the received message on the facsimile machine 3 (in step S523). FIG. 10 shows an exemplary task related information list including relevant items of “task name” and “related information”. A user may put a check-mark in the “send” column on the paper on which the task related information list is printed, and send the marked paper by facsimile as a request to acquire the contents of the marked related information. In addition, when the list is not printed, a user may also request to acquire the contents of desired related information by putting a check-mark on the task related information list on a display of, for example, a computer and sending the marked data by facsimile transmission.

Further, in FIG. 9B, an outside user U2 gives an instruction to a facsimile machine 3 to acquire the contents of the desired related information (in step S524). The facsimile machine 3 sends the message to the facsimile subsystem 26 in the workflow management system 2 (in step S525). After receiving the message correctly, the facsimile subsystem 26 informs the facsimile machine 3 of the receipt of the message (in step S526). Then, the facsimile subsystem 26 informs the workflow engine 22 of the sender's information (facsimile number) and facsimile received information including received image information (in step S527).

Next, the workflow engine 22 sends the received image information, task related information list rendering information (layout information of the “related information” and “send” columns in the image of the task related information list), and a text information extraction request to the image processing engine 27 (in step S528). The image processing engine 27 extracts text information from the received image information using an analysis technique such as OCR, confirms the positions of, for example, the check-mark using the task related document list rendering information, identifies the relation information that the user requests to acquire (in step S529), and sends the identified task related document list back to the workflow engine 22 (in step S530).

Then, the workflow engine 22 requests to send the task related information to the related information DB 231 (in step S531), and acquires the task related information (in step S532).

Then, the workflow engine 22 sends an instruction to the facsimile subsystem 26 to inform the user U2 by facsimile machine of the task related information (in step S533). The instruction to send a facsimile message includes information to identify the facsimile machine 3 of the user U2 (received sender's information, operator's facsimile number in FIG. 4).

The facsimile subsystem 26 sends the message by facsimile to the facsimile machine 3 (in step S534), receives information that the facsimile machine 3 has correctly received the message from the facsimile subsystem 26 when the message is correctly received (in step S535), and informs the workflow engine 22 that the message transmission is completed (in step S536). The workflow engine 22 sends a request to the task instance DB 233 to update the status of the transmitted task related information (in step S537), and is informed that the update is completed when the update is correctly completed (in step S538).

In addition, the user U2 confirms the received message on the facsimile machine 3 (in step S539).

In the above description, facsimile transmission is used to inform the user U2 that the registration of the related information is completed. However, instead of using the facsimile, only e-mail or both facsimile and e-mail may be used. In such a case, a message transmission request along with a mail address (operator's e-mail address in FIG. 4) is to be transmitted to the electronic mail subsystem 25.

Further, in the above description, the message is transmitted to the user U2 who performs the facsimile transmission. However, the process may be modified so that the message can be sent to other users relevant to the task (a creator or a user relevant to the task or the upper task of the task or uppermost workflow (project)) in addition to the user U2 by any one of facsimile and e-mail or both.

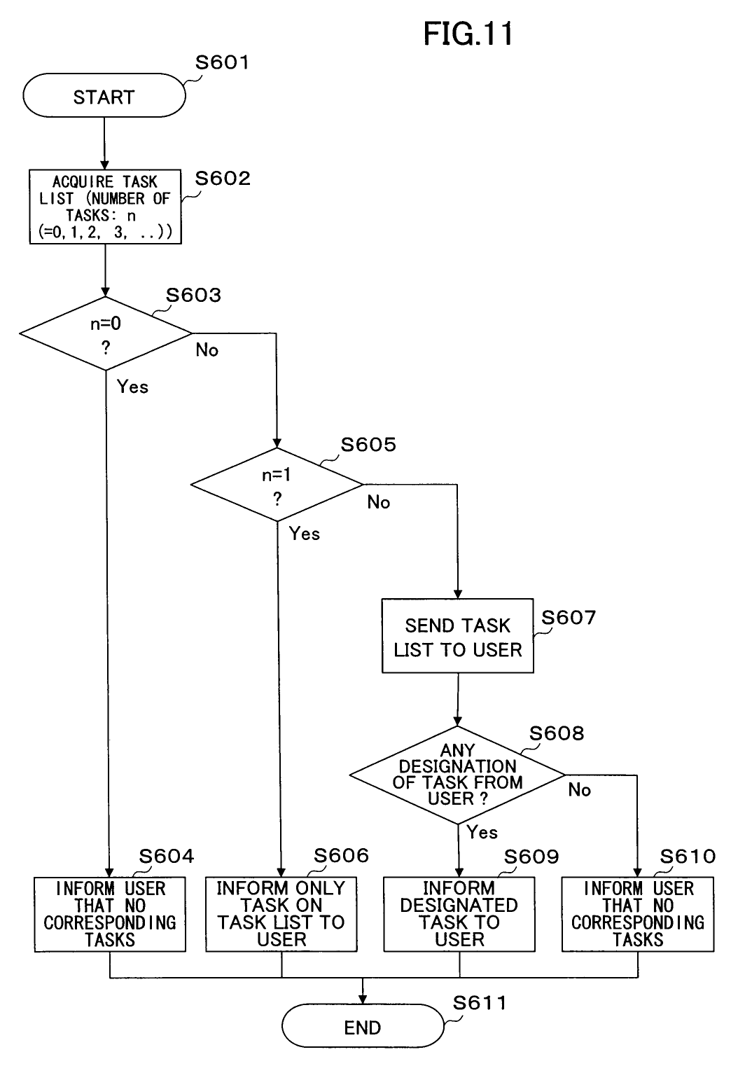

FIG. 11 is a flowchart of an exemplary process showing what information is provided depending on cases to a user in an interactive mode. Namely, when the related information registration request is issued in steps S109 in FIG. 5, S319 in FIG. 7, S419 in FIG. 8, and S519 in FIG. 9A, the related information is automatically registered in the tasks of the task list previously obtained in the task search. However, there may be a problem when there is related information that should not be registered in the searched for and found task. To solve the problem, an interactive process depending on the number of searched for and found tasks is provided in the flowchart of FIG. 11. The process shown in FIG. 11 may be interposed between steps S108 and S109 in FIG. 5, between steps S318 and S319 in FIG. 7, between steps S418 and S419 in FIG. 8, and between steps S518 and S519 in FIG. 9A. It should be noted that whether the process is performed automatically or manually (interactive mode) may be previously input by a user or input as facsimile information.

In FIG. 11, after the process starts (in step S601), the task list is acquired, and the number of the tasks “n” (n=0, 1, 2, . . . ) is confirmed (in step S602).

Next, it is determined whether the number of the tasks “n” is “0” in step S603. When it is determined that the number of the tasks “n” is “0” (Yes in step S603), a message that no task is to be searched for is sent to the user U2 (in step S604) and the process ends (in step S611). In this case, no further related information is registered.

When it is determined that the number of the tasks “n” is other than “0” (No in step S603), it is further determined whether the number of the tasks “n” is “1” (in step S605). When it is determined that the number of the tasks “n” is “1” (Yes in step S605), the information of the only task in the task list is sent to the user U2 (in step S606) and the process ends (in step S611).

When it is determined that the number of the tasks “n” is other than “1” (No in step S605), the task list is sent to the user U2 (in step S607). Then, it is determined whether the user U2 designates a task (in step S608). When it is determined that the user U2 designate a task (Yes in step S608), the information of the designated task is sent to the user U2 (in step S609) and the process ends (in step S611).

When it is determined that the user U2 does not designate a task (No in step S608), a message that no task has been designated is sent to the user U2 (in step S610) and the process ends (in step S611). In this case, no further related information is registered.

It should be noted that a process of limiting the tasks where the related information is registered is not limited to the process depending on the number of the searched for and found tasks as described above. The tasks where the related information is registered can be limited by, for example, designating the task by the user U2 using a prescribed format.

### <Overview>

As described above, a workflow management system according to an embodiment of the present invention includes the following advantages:

(1) In a network connecting apparatuses such as a personal computer, a workstation, a printer, a facsimile machine, and a scanner, information managed in a facsimile machine can be seamlessly linked with a digital workflow (task information).
(2) By acquiring image information, sender's information, and destination information from a facsimile machine, it becomes possible to capture image information transmitted using a facsimile machine directly into a workflow without printing the image information on a paper.
(3) By analyzing the digital information received by a facsimile machine, it becomes possible to avoid missing information that may occur when the digital information is printed on a paper, and to reduce unnecessary paper consumption.
(4) A document related to a task can be transmitted via a facsimile machine. Therefore a user where only a facsimile line is available can receive a document related to a task via a facsimile machine.

The present invention is not limited to the above exemplary embodiments, and variations and modifications may be made without departing from the scope of the present invention. Further, the present invention should not be interpreted to be limited by the descriptions and accompanying drawings.

The present application is based on and claims the benefit of priority of Japanese Patent Application No. 2007-071603, filed on Mar. 19, 2007, the entire contents of which are hereby incorporated herein by reference.

What is claimed is:

1. A workflow management system capable of being dynamically configured by re-using a part of a workflow during the workflow execution, the workflow management system comprising:
an object identifying unit identifying an object to be associated with image information received by a facsimile machine, the object being defined in the workflow management system; and
a related document registering unit associating the image information with the identified object, and registering the image information associated with the identified object.

2. The workflow management system according to claim 1, wherein
the object identifying unit identifies the object based on a sender's information of the received image information.

3. The workflow management system according to claim 2, further comprising:
a unit omitting a subsequent process when the sender's information is registered to be blocked.

4. The workflow management system according to claim 1, wherein
the object identifying unit extracts text information included in the received image information, and identifies the object based on the extracted text information.

5. The workflow management system according to claim 4, further comprising:
a unit changing a task configuration of the workflow when a prescribed term is included in the extracted text information.

6. The workflow management system according to claim 1, further comprising:
a unit informing a user relevant to the object that the received image information is registered when the related information registering unit associates the image information received by the facsimile machine with the identified object, and registers the image information associated with the identified object.

7. The workflow management system according to claim 1, further comprising:
a unit providing related information associated with the object to a user relevant to the object when the related information registering unit associates the image information received by the facsimile machine with the identified object, and registers the image information associated with the identified object.

8. A method of managing workflow management system capable of being dynamically configured by re-using a part of a workflow during the workflow execution, the method comprising:
a step of identifying an object to be associated with image information received by a facsimile machine, the object being defined in the workflow management system; and
a step of associating the image information with the identified object, and registering the image information associated with the identified object.

9. A program for controlling a workflow management system capable of being dynamically configured by re-using a part of a workflow during the workflow execution, the program causing a computer to perform the step of:
identifying an object to be associated with image information received by a facsimile machine, the object being defined in the workflow management system; and
associating the image information with the identified object, and registering the image information associated with the identified object.
